(19) United States
(12) Patent Application Publication
(10) Pub. No.: US 2014/0280531 A1
(43) Pub. Date: Sep. 18, 2014

(54) OBJECT RANKING AND RECOMMENDATIONS WITHIN A SOCIAL NETWORK

(71) Applicants: Xin Liu, Palo Alto, CA (US); Wei Xu, Los Gatos, CA (US)

(72) Inventors: Xin Liu, Palo Alto, CA (US); Wei Xu, Los Gatos, CA (US)

(21) Appl. No.: 13/800,633

(22) Filed: Mar. 13, 2013

(51) Int. Cl. H04L 29/08

(52) U.S. Cl. CPC H04L 67/22
USPC 709/204

(57) ABSTRACT

Exemplary methods, apparatuses, and systems receive a first user action, by a user within a network service, with respect to a first object displayed or referenced on the network service. Demographic information for the user is received and a counter for a category representing the first user action, the first object, and the demographic information is identified and incremented. The demographic information may include a history of a second user action with respect to a second object. Counters with the highest values for a category represent the highest ranked objects in the category. Upon receipt of a request for a number of objects for the category, objects that correspond to counters with the highest values for the category are selected and transmitted as a ranked list of recommended objects for display by a user.

### FIELD

The various embodiments described herein relate to ranking and recommending objects within a social network. In particular, the embodiments relate to the utilization of a social networking platform to rank objects based upon user actions within the social network and corresponding user demographic information and to provide timely, socially relevant, and personalized recommendations based upon the rankings.

### BACKGROUND

A social networking system allows users to designate other users or entities as connections (or otherwise connect to, or form relationships with, other users or entities), contribute and interact with their connections, post media or commentary, use applications, join groups, list and confirm attendance at events, invite connections, and perform other tasks that facilitate social interaction. External applications also use the services of a social networking system to allow authenticated users to incorporate some of the above social interactions with use of the external applications.

### SUMMARY OF THE DESCRIPTION

Exemplary methods, apparatuses, and systems receive a first user action, by a user within a network service, with respect to a first object displayed or referenced on the network service. Demographic information for the user is received and a counter for a category representing the first user action, the first object, and the demographic information is identified and incremented. In one embodiment, the demographic information includes a history of a second user action with respect to a second object. A similarity or other correlation may be detected based upon the counter value for a counter for a category representing the first and second user actions and the first and second objects. In one embodiment, counters with the highest values for a given category represent the highest ranked objects in that category. Upon receipt of a request for a number of objects for the category, objects that correspond to counters with the highest values for the category are selected and transmitted as a ranked list of recommended objects for display by a user.

Other features and advantages will be apparent from the accompanying drawings and from the detailed description.

### BRIEF DESCRIPTION OF THE DRAWINGS

The present invention is illustrated by way of example and not limitation in the figures of the accompanying drawings, in which like references indicate similar elements, and in which:

FIG. 1 is a flow chart illustrating an exemplary method of ranking an object within a social network;

FIG. 2 illustrates an exemplary graph of user actions with respect to objects within the social network;

FIG. 3 illustrates an exemplary graph of connections and user profiles within the social network;

FIG. 4 is a flow chart illustrating an exemplary method of recommending objects within the social network based upon the object rankings;

FIG. 5 illustrates, in block diagram form, an exemplary social network; and

FIG. 6 illustrates, in block diagram form, an exemplary processing system to rank and recommend objects within a social network.

### DETAILED DESCRIPTION

Embodiments described herein rank objects within a social network based upon user actions and demographics. Using these rankings, the network service is able to make personalized as well as temporally and socially relevant recommendations of objects.

FIG. 1 is a flow chart illustrating an exemplary method 100 of ranking an object within a social network based upon user actions with respect to the object. A social networking service enables a user to broadcast to a set of connections within the social network. Broadcasts include publications of actions with respect to objects. As used herein, an object is a noun within the publication and represents an entity, item, or location. As used herein, an action is a verb within the publication that corresponds to an object. Exemplary objects include, but are not limited to, articles, blogs, books, profiles, movies, television shows/episodes, videos, images, websites, cities, individuals, businesses, organizations, groups, and public figures. Exemplary actions include, but are not limited to, like, read, listen, watch, view, friend, follow, subscribe, share, republish, and comment.

At block 105, a processing system receives a user action within network service with respect to a first object. For example, a user may publish, or an application may post on the user's behalf, that the user is listening (action) to a song (object).

FIG. 2 illustrates an exemplary graph 200 of user actions with respect to objects within the social network. In graph 200, objects are illustrated as circles and actions are illustrated as rectangles. User A has performed a number of actions within the social network, indicating that he has lived in Boston, currently lives in Washington D.C., joined groups for Democrats and ConLaw Lovers, is following the White Sox, and is friends with User B. User B and User C have also performed a number of actions with respect to objects within graph 200. Developers of the social network or corresponding applications define customized actions to represent different ways that users may interact with the social network and/or their applications. When a user performs an action, it is published to the social network.

In one embodiment, users may select privacy settings to control what actions are shared, with whom actions are shared, and/or what actions are used for ranking and recommending objects.

Referring back to FIG. 1, at block 110, the processing system receives demographic information for the user. Exemplary demographic information includes gender, age, hometown, current location, school attended, organization membership, religious affiliation, level of education, relationship status, occupation, and information about connections within the social network. In one embodiment, users may select privacy settings to control what demographic information is shared/published and/or may be used for ranking and recommending objects.

In one embodiment, demographic information includes the user's past activity within the social network. Following the example of liking a song above, the demographic information may include the user previously broadcasting that she likes another song. The demographic information indicates a potential correlation or similarity between objects.

FIG. 3 illustrates an exemplary graph 300 of connections and user profiles within the social network. The illustrated connections and profiles are exemplary demographic information to be used for ranking and recommending objects. In one embodiment, as users perform actions, e.g., as described with reference to FIG. 2, connections are made between users and objects. This history of user actions creates demographic information about the users.

In one embodiment, users are able to add demographic information to user profiles 305A-C. In one embodiment, for demographic information that has not been entered by a user, a social network application generates an estimate based upon the user's actions, connections, and/or actions of connections.

In FIG. 3, there is an overlap between connected objects in the graph 300 (e.g., created by actions, as described above) and information entered into a user profile 305. In one embodiment, the social network application interprets the user's act of adding information to a user profile 305 as an action upon an object. For example, User A added Washington D.C. to his profile 305A in the category City. The social network application creates an action corresponding to User A lives in Washington D.C. Alternatively, connections created by past actions do not overlap with profile information.

In one embodiment, demographic data further includes a weight or score indicating an affinity between a user and an object. For example, repeated user action with one object may indicate a stronger affinity for said object than another object with which the user has limited interaction. First degree connections, e.g., the friendship between User A and User B, may indicate a stronger affinity than second degree connections, e.g., User A is friends with User B, who is friends with User C, creating a second degree connection between User A and User C. An indication that two users are married may indicate a stronger affinity than if two users are friends. Additionally, temporal and geographic proximity of actions/users are other exemplary indicators of affinity.

Referring back to FIG. 1, at block 115, the processing system identifies a counter for a category representing the user action, the object, and the demographic information. Counters are defined by one or more of the object, object type, object description/metadata, action, action type, action metadata (time, location, etc.), and demographic information about the user and/or user's connections. For example, a counter may be defined for listening (action) to the song, Gangnam Style (object), by a male living in Washington D.C. This counter may fit within one or more categories, such as the exemplary categories of songs listened to by males living in Washington D.C., songs listened to by users in Washington D.C., and locations where males/users listen to Gangnam Style.

In one embodiment, the processing system identifies multiple counters that correspond to the user action, object, and demographic information. In addition to the exemplary counter defined above, another counter may be defined for a male living in Washington D.C. and above the age of 50 listening to the song, Gangnam Style. This additional counter would fit into the exemplary categories described above as well as additional categories based upon the age demographic.

At block 120, the processing system increments the identified counter(s). As the counter for an object within a category increases, the processing system estimates a greater correlation or similarity between that object and another object, action, and/or demographic defined by the category. In one embodiment, the processing system determines that there is a correlation or similarity between an object and another object, action, and/or demographic based upon one or more of the counter exceeding a threshold value, the counter maintaining a value for a particular amount of time, the counter positioning the object at a threshold ranking among objects within the category, the counter maintaining a minimum ranking for an amount of time, etc.

In one embodiment, each user action results in an equivalent increment value. Alternatively, user actions are weighted differently and increment counters at greater or lesser amounts. For example, the action of sharing an object may be attributed a greater increment value than liking the object. Repetitions of the same action by the same user on the same object may be attributed a different incremental value than the original action. In one embodiment, the affinity between a user and an object, as described above, alters the weight of the increment value. In one embodiment, a greater estimated social influence of the user (e.g., based upon friends, fans, connections, subscribers, interactions, etc.) results in a greater increment value.

In one embodiment, the processing system increments the counter as a part of a batch update process. Increment values for identified counters are temporarily stored and, at a trigger event (time interval, upon reaching a threshold number of counter updates, etc.), the updates are applied to corresponding counters.

At block 125, the processing system optionally decays the counter. In one embodiment, counters are decayed linearly over time. Alternatively, counters are decayed exponentially over time. In one embodiment, counters are decayed at different rates depending upon the action and/or object represented by the counter. For example, news articles may have a limited relevance as time passes while music may remain relevant for a greater period of time. Accordingly, a counter representing users reading a news article may decay more rapidly than a counter representing users listening to a song. In one embodiment, the decay of a counter may be a decrement value included within the above-described batch update.

At block 130, the processing system determines or updates the ranking of objects within the category. In one embodiment, the processing system maintains a list of the top K objects for a category based upon counter values (K being an integer). As counter values are incremented and/or decayed, objects in a category are adjusted to higher or lower corresponding rankings within, or outside of, the top K. For example, the processing system may implement one or more sorting algorithms to place objects in a list ordered from highest counter value to lowest counter value. As user actions are continually received, and counters are incremented and/or decayed, the processing system maintains a temporarily relevant ranking of objects based upon demographic information, which can be transmitted and displayed as described below.

FIG. 4 is a flow chart illustrating an exemplary method 400 of recommending objects within the social network based upon the object rankings. At block 405, the processing system receives a request for the highest ranked or top K recommended objects for a category. Utilizing the categories that define the counters, the processing system generates recommendations tailored to specific users/requests. For example, a request may be for the top K songs for male users living in Washington D.C. An additional example includes a request for the top K videos for male users who have liked or listened to the song, Gangnam Style. If the highest counter for male users who have liked or listened to the song, Gangnam Style corresponds to male users who have also watched Internet meme videos, the processing system can generate a recommendation to a male user listening to Gangnam style to watch said Internet meme videos.

At block 410, the processing system selects the highest ranked objects for the category. As described above, as counters are incremented and/or decayed, the processing system maintains the ranking of objects within categories. In one embodiment, the processing system selects the top K objects. Alternatively, the processing system selects less than K objects. For example, if less than K objects have counters above 0 or another minimum threshold, the processing system selects only those objects with counters above the minimum threshold. The use of such a minimum threshold may avoid premature recommendations/correlations based upon a lack of data or corresponding activity.

At block 415, the processing system transmits a list of the highest ranked objects (e.g., the top K objects) for the category in response to the received request.

FIG. 5 illustrates, in block diagram form, an exemplary social network 500. The exemplary social network 500 includes user devices 505, a social networking system 510, and an external server 515 coupled to one or more networks 520. A user interacts with the social networking system 510 using a user device 505, such as a personal computer or a mobile phone. For example, the user device 505 communicates with the social networking system 510 via an application such as a web browser or native application. Typical interactions between the user device 505 and the social networking system 510 include operations such as viewing profiles of other users of the social networking system 510, contributing and interacting with media items, joining groups, listing and confirming attendance at events, checking in at locations, liking certain pages/posts, creating pages, and performing other tasks that facilitate social interaction, as described herein. Each of these interactions is an exemplary interaction of a user accessing the social networking system as a network service.

The social networking system 510 includes platform storage 525, a recommendation service 530, one or more application programming interfaces (API's) 535, a social graph 540 (e.g., as illustrated in FIG. 3), and one or more platform applications 545. Platform storage 525 stores user preferences/settings, profile data, etc. Exemplary platform applications 530 include the platform for social interactions (e.g., publishing posts, pictures, etc.) as well as social games, messaging services, and any other application that uses the social platform provided by the social networking system 510.

In one embodiment, one or both of the methods 200 and 400 described above are performed by the recommendation service 530 and/or a platform application 545, demographic data is received from platform storage 525 and/or the social graph 540, and the counters are stored in platform storage 525. Alternatively, one or more of the methods and/or data is performed/stored external to the social networking system 510.

One or more API's 535 enable external applications 550 to work with the social networking system 510. For example, an external application 550 utilizes an API 535 to authenticate a user based upon the user's social networking log in username and password. Additionally, an external application 550 utilizes one or more API's 535 to run the application within the platform application 530, to publish a post to the platform application, to access the user's social network connections, etc. In one embodiment, one or both of the methods 200 and 400 described above are performed by an external application 550 and data is received from and/or stored in one or both of external storage 545 or in platform storage 525.

FIG. 6 illustrates, in block diagram form, an exemplary processing system 600 to rank and recommend objects within a social network. Data processing system 600 includes one or more microprocessors 605 and connected system components (e.g., multiple connected chips). Alternatively, the data processing system 600 is a system on a chip.

The data processing system 600 includes memory 610, which is coupled to the microprocessor(s) 605. The memory 610 may be used for storing data, metadata, and programs for execution by the microprocessor(s) 605. The memory 610 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 610 may be internal or distributed memory.

The data processing system 600 also includes an audio input/output subsystem 615 which may include a microphone and/or a speaker for, for example, playing back music or other audio, receiving voice instructions to be executed by the microprocessor(s) 605, playing audio notifications, etc. A display controller and display device 620 provides a visual user interface for the user.

The data processing system 600 also includes one or more input or output (“I/O”) devices and interfaces 625, which are provided to allow a user to provide input to, receive output from, and otherwise transfer data to and from the system. These I/O devices 625 may include a mouse, keypad or a keyboard, a touch panel or a multi-touch input panel, camera, optical scanner, network interface, modem, other known I/O devices or a combination of such I/O devices. The touch input panel may be a single touch input panel which is activated with a stylus or a finger or a multi-touch input panel which is activated by one finger or a stylus or multiple fingers, and the panel is capable of distinguishing between one or two or three or more touches and is capable of providing inputs derived from those touches to the processing system 600.

The I/O devices and interfaces 625 may also include a connector for a dock or a connector for a USB interface, FireWire, Thunderbolt, Ethernet, etc. to connect the system 600 with another device, external component, or a network. Exemplary I/O devices and interfaces 625 also include wireless transceivers, such as an IEEE 802.11 transceiver, an infrared transceiver, a Bluetooth transceiver, a wireless cellular telephony transceiver (e.g., 2G, 3G, 4G, etc.), or another wireless protocol to connect the data processing system 600 with another device, external component, or a network and receive stored instructions, data, tokens, etc.

It will be appreciated that one or more buses, may be used to interconnect the various components shown in FIG. 6.

The data processing system 600 is an exemplary representation of one or more of the user's device 505, at least a portion of the social networking system 510, or the external server 515. The data processing system 600 may be a personal computer, tablet-style device, a personal digital assistant (PDA), a cellular telephone with PDA-like functionality, a Wi-Fi based telephone, a handheld computer which includes a cellular telephone, a media player, an entertainment system, or devices which combine aspects or functions of these devices, such as a media player combined with a PDA and a cellular telephone in one device. In other embodiments, the data processing system 600 may be a network computer, server, or an embedded processing device within another device or consumer electronic product. As used herein, the terms computer, device, system, processing system, processing device, and “apparatus comprising a processing device” may be used interchangeably with the data processing system 600 and include the above-listed exemplary embodiments.

It will be appreciated that additional components, not shown, may also be part of the system 600, and, in certain embodiments, fewer components than that shown in FIG. 6 may also be used in a data processing system 600. It will be apparent from this description that aspects of the inventions may be embodied, at least in part, in software. That is, the computer-implemented methods 200 and 400 may be carried out in a computer system or other data processing system 510/515/600 in response to its processor or processing system 605 executing sequences of instructions contained in a memory, such as memory 610 or other non-transitory machine-readable storage medium. The software may further be transmitted or received over a network (not shown) via a network interface device 625. In various embodiments, hardwired circuitry may be used in combination with the software instructions to implement the present embodiments. Thus, the techniques are not limited to any specific combination of hardware circuitry and software, or to any particular source for the instructions executed by the data processing system 600.

An article of manufacture may be used to store program code providing at least some of the functionality of the embodiments described above. Additionally, an article of manufacture may be used to store program code created using at least some of the functionality of the embodiments described above. An article of manufacture that stores program code may be embodied as, but is not limited to, one or more memories (e.g., one or more flash memories, random access memories—static, dynamic, or other), optical disks, CD-ROMs, DVD-ROMs, EPROMs, EEPROMs, magnetic or optical cards or other type of non-transitory machine-readable media suitable for storing electronic instructions. Additionally, embodiments of the invention may be implemented in, but not limited to, hardware or firmware utilizing an FPGA, ASIC, a processor, a computer, or a computer system including a network. Modules and components of hardware or software implementations can be divided or combined without significantly altering embodiments of the invention.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

It will be evident that various modifications may be made thereto without departing from the broader spirit and scope of the invention as set forth in the following claims. For example, the methods described herein may be performed with fewer or more features/blocks or the features/blocks may be performed in differing orders. Additionally, the methods described herein may be repeated or performed in parallel with one another or in parallel with different instances of the same or similar methods.

What is claimed is:

1. A computer-implemented method, comprising:
receiving a first user action from a user within a network service, the action with respect to a first object displayed or referenced on the network service;
receiving demographic information about the user;
identifying a counter for a category representing the first user action, the first object, and the demographic information;
incrementing the identified counter;
receiving a request for a number of objects for the category;
selecting up to the number of objects that correspond to counters with the highest values for the category; and
transmitting, in response to the request, the selected of objects as a ranked list of recommended objects for display by a user.

2. The computer-implemented method of claim 1, wherein the demographic information includes a history of a second user action, by the user within the network service, with respect to a second object displayed or referenced on the network service, and wherein the identified counter further represents the second user action and the second object.

3. The computer-implemented method of claim 2, further comprising:
detecting a similarity between the first object and the second object based upon a value of the identified counter.

4. The computer-implemented method of claim 1, further comprising:
decrementing the counter at a decay rate, wherein the decay rate is determined based upon the type of object represented by the counter.

5. The computer-implemented method of claim 1, further comprising:
determining an action type for the user action, wherein an amount by which the identified counter is incremented is dependent upon the action type.

6. The computer-implemented method of claim 1, wherein the identified counter is one of a plurality of counters, and wherein incrementing the identified counter includes storing the amount by which the identified counter is to be incremented along with increment values for another of the plurality of counters and performing a batch update of the identified counter and the other counter.

7. A non-transitory computer-readable medium storing instructions that, when executed by a processor, cause a processor to perform a method comprising:
receiving a first user action from a user within a network service, the action with respect to a first object displayed or referenced on the network service;
receiving demographic information for the user;
identifying a counter for a category representing the first user action, the first object, and the demographic information;
incrementing the identified counter;
receiving a request for a number of objects for the category;
selecting up to the number of objects that correspond to counters with the highest values for the category; and
transmitting, in response to the request, the selected of objects as a ranked list of recommended objects for display by a user.

8. The non-transitory computer-readable medium of claim 7, wherein the demographic information includes a history of a second user action, by the user within the network service, with respect to a second object displayed or referenced on the network service, and wherein the identified counter further represents the second user action and the second object.

9. The non-transitory computer-readable medium of claim 8, the method further comprising:
detecting a similarity between the first object and the second object based upon a value of the identified counter.

10. The non-transitory computer-readable medium of claim 7, the method further comprising:
decrementing the counter at a decay rate, wherein the decay rate is determined based upon the type of object represented by the counter.

11. The non-transitory computer-readable medium of claim 7, the method further comprising:
determining an action type for the user action, wherein an amount by which the identified counter is incremented is dependent upon the action type.

12. The non-transitory computer-readable medium of claim 7, wherein the identified counter is one of a plurality of counters, and wherein incrementing the identified counter includes storing the amount by which the identified counter is to be incremented along with increment values for another of the plurality of counters and performing a batch update of the identified counter and the other counter.

13. An apparatus, comprising:
a processing device, wherein the processing device executes instructions that cause the apparatus to
receive a first user action from a user within a network service, the action with respect to a first object displayed or referenced on the network service;
receive demographic information for the user;
identify a counter for a category representing the first user action, the first object, and the demographic information;
increment the identified counter;
receive a request for a number of objects for the category;
select up to the number of objects that correspond to counters with the highest values for the category; and
transmit, in response to the request, the selected of objects as a ranked list of recommended objects for display by a user.

14. The apparatus of claim 13, wherein the demographic information includes a history of a second user action, by the user within the network service, with respect to a second object displayed or referenced on the network service, and wherein the identified counter further represents the second user action and the second object.

15. The apparatus of claim 14, wherein the processing device executes instructions that cause the apparatus to:
detect a similarity between the first object and the second object based upon a value of the identified counter.

16. The apparatus of claim 13, wherein the processing device executes instructions that cause the apparatus to:
decrement the counter at a decay rate, wherein the decay rate is determined based upon the type of object represented by the counter.

17. The apparatus of claim 13, wherein the processing device executes instructions that cause the apparatus to:
determining an action type for the user action, wherein an amount by which the identified counter is incremented is dependent upon the action type.

18. The apparatus of claim 13, wherein the identified counter is one of a plurality of counters, and wherein incrementing the identified counter includes storing the amount by which the identified counter is to be incremented along with increment values for another of the plurality of counters and performing a batch update of the identified counter and the other counter.
